(19) United States
(12) Patent Application Publication
(10) Pub. No.: US 2014/0363591 A1
(43) Pub. Date: Dec. 11, 2014

(54) Surface covering with an irregular undulating edge

(71) Applicant: LCF Holding OU, Harju maakond (EE)

(72) Inventors: Erki Unn, Valgamaa (EE); Taavi Velleste, Tallinn (EE)

(73) Assignee: LCF Holding OU, Harju maakond (EE)

(21) Appl. No.: 14/074,788

(22) Filed: Nov. 8, 2013

(30) Foreign Application Priority Data
Jun. 6, 2013 (EE) U201300060

(51) Int. Cl. B44F 9/02

(52) U.S. Cl. CPC B44F 9/02
USPC 428/17

(57) ABSTRACT

The invention describes a surface covering that comprises modules, made up of elements with irregular undulating edge, imitating natural warping of wood. At least one element with irregular undulating edge of a module is unique and an element with at least one irregular undulating edge can be matched, according to the predefined specification, side to side, with at least one adjacent element with irregular undulating edge. Unique element of each module, featuring at least one irregular undulating edge, will be interchangeable with the unique element with an equivalent irregular undulating edge that forms a part of another module. Modules can be matched mutually, at horizontal plane, to the shape of irregular undulating edge of the outmost element of module, at least in part, according to the predefined specification, given above; the modules can be also matched to each other at ends, according to the predefined specification, thus forming a repeating pattern.

### PRIORITY CLAIM

This application claims priority of Estonian application number U201300060 filed on Jun. 6, 2013, the contents of which are incorporated herein by reference.

### TECHNICAL FIELD

The invention relates to a surface covering comprising modules, which are built of elements with an irregular undulating edge that imitates the natural warping of wood, and form a repeating pattern.

### PRIOR ART

Known are wooden flooring or panelling that are used for covering indoor and outdoor surfaces. With these solutions the surface is covered with a number of adjacent boards or panels. Usually these boards or panels are in the shape of a rectangle with straight edges, which contributes to convenient side by side positioning.

The solution in prior art, known to be closest to the given invention, are individual flooring boards (elements) with irregular undulating edge that follow natural curvature and are matched to one another one by one by edges on the basis of a predefined specification, to form a complete floor.

The shortcomings of this solution are:
as each flooring board with irregular undulating edge is unique, finding for each individual board a matching counterpart with edges that would match at least partially is extremely time-consuming and labour-intensive—historically, each such floor board with a undulating edge was produced manually, while today a special computer software is used for the purpose, which still requires individual production of each unique floor board;
as each floor board with irregular undulating edge is unique, the elements (floor boards) cannot be interchanged or replaced with one another later during the use of the floor—this makes the installation of the floor time-consuming (should some of the elements break, turn out to be of poor quality, etc.) and replacing single elements during the use of the floor is extremely complicated;
ordering a whole floor with correct dimensions is complicated and requires the involvement of a specialist of the respective field, to measure the exact surface area of the future floor and the angles of its boundaries (walls, steps, etc.);
as each element is unique, installation of the floor is complicated and requires involvement of a person skilled in the art.

Due to the above-named shortcomings, the production of the solution known from prior art is recourse-intensive, wherefore the end product also becomes expensive for the client and involves complicated installation.

### SUMMARY OF THE INVENTION

It is an object of this invention to provide an economic and easy solution to install covering with undulating edge that imitates natural warping of wood.

It is an object of this invention to provide a surface covering with an irregular undulating edge, comprising of unique irregular elements matched to one another sideways with undulating edge, wherein at least one element with irregular undulating edge with the shape of its edge at horizontal plane is by predefined specification at least partially compatible sideways with at least one adjacent element with irregular undulating edge, forming a module; an element of a module with at least one irregular undulating edge is unique; a unique element of a module with at least one irregular undulating edge can be replaced with an equal unique element with an irregular undulating edge of another module; modules can be matched mutually, at horizontal plane, to the shape of irregular undulating edge of the outmost element of a module, at least in part, according to the predefined specification; modules can be matched to each other at ends, according to the predefined specification; modules form a repeating pattern.

It is an object of this invention to provide a surface covering with an irregular undulating pattern imitating natural warping of wood, comprising one or more modules, where each module comprises a multitude of elements having two longitudinal edges and two short edges,

wherein at least one longitudinal edge of each element has an undulating edge and said undulating edge having a predetermined shape such that it matches at least partially with an undulating edge of another element, and where the short ends of the elements are matching.

### SHORT DESCRIPTION OF THE DRAWINGS

FIG. 1 depicts module's elements with undulating edge detached from one another. The predetermined specification (A1, A2, . . . , B1, B2, . . . ) that helps in matching the elements to one another is visible on the elements.

FIG. 2 depicts a complete module. The predetermined specification (A1, A2, . . . , B1, B2, . . . ), which helps in combining the elements in a module, can be seen on the elements.

FIG. 3 depicts a surface covering with a repeating pattern, consisting of three matched modules. The predetermined specification (A1, A2, . . . , B1, B2, . . . ), which helped in combining the elements into a module and the modules to one another can be seen on the elements.

### DESCRIPTION OF THE INVENTION

According to the invention, a module comprising unique elements with undulating edge that imitates the natural warping of wood, has been developed, forming a surface covering with a repeating pattern when mutually matched together.

Production (mass production) of such surface covering is cost-effective and therefore its sales price would be affordable for consumers and it would also be easy for consumers to produce/install a complete surface covering by themselves of these modules according to their needs. It could be the surface covering of e.g. floor, wall, ceiling, or some worktop (kitchen countertop, top panels of sanitary rooms, kitchen table, writing desk, sauna benches, etc.).

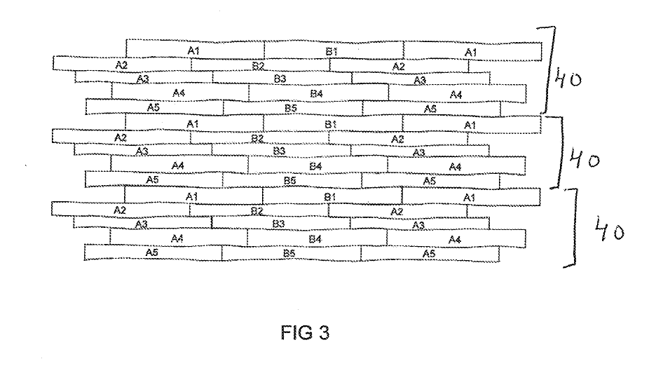

The module (40) consists of at least two elements (10) with irregular longitudinal undulating edge (20), which are matched together. The maximum number of elements in a module or the number of modules in a surface covering is virtually infinite, but is restricted by the need of the consumer, the size of the area for installing the surface covering, use of the modules and/or elements for commercial applications (e.g. packaging of goods, transportation for retail purposes), etc. FIG. 3 shows an example with three modules matched together.

At least one element with irregular undulating edge in a module is unique. At least one element with irregular undulating edge in a module with the shape of its edge at horizontal plane is by predefined specification at least partially compatible sideways (along its longitudinal undulating edge) with at least one adjacent element with irregular undulating edge. The sideways compatibility of at least a part of the elements means that the ends (30) in a module may be, but are not necessarily with different lengths, i.e. are at different horizontal planes.

The covering of this invention is provided in identical modules. Therefore a unique element with at least one irregular undulating edge of one module can be replaced with a similar unique element with an irregular undulating edge of another module.

Modules can be matched mutually, at horizontal plane, to the shape of irregular undulating edge of the outmost elements of a module, at least in part, according to the predefined specification. Modules can also be matched to each other at ends, according to the predefined specification, thus forming a repeating pattern. Formation of a repeating pattern requires matching of at least two modules.

The definition above means that each unique element with irregular undulating edge in a module is marked so that it would be possible to find both inside the module and between different modules a counterpart in the form of an element with irregular undulating edge compatible at least partially with the shape of the edge at horizontal plane. According to such predefined specifications the modules can also be matched to each other at ends. This contributes to easy formation of modules out of elements, and a complete modular covering of a surface with a repeating pattern.

The elements are mutually connected by methods common among the person skilled in the art. The material of the elements can also be a material commonly used in case of surface coverings.

More detailed exemplary embodiments of the invention are provided in the figures and in the descriptions of exemplary, non limiting embodiments.

### Exemplary Embodiments

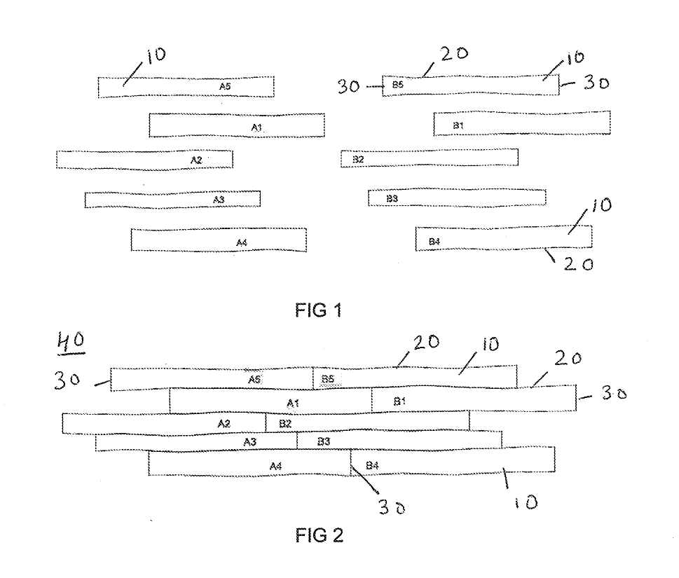

According to the embodiment presented in FIG. 1, a module comprises ten unique elements (10) A1-A5, B1-B5 with two irregular longitudinal undulating edges (20). According to a predetermined specification, each element is sideways at least partially compatible by the shape of one of its longitudinal edge (20) at horizontal plane with at least one irregular undulating longitudinal edge (20) of an adjacent element.(10). For example, the elements that are sideways mutually compatible in FIG. 1 are A1 and A2, B1 and B2, A2 and A3, B2 and B3, etc.

Now referring to FIG. 2: Elements (10) A1 and B1, A2 and B2, etc. can be matched to each other at their short ends (30) , thereby forming a module (40).

FIG. 3 presents the embodiment of a surface covering with a repeating pattern, formed of several modules (40) each consisting of ten unique elements (10) with irregular undulating edges (20). The modules are mutually matched, at horizontal plane, at least partially to the shape of irregular undulating edge of the outermost element of a module, according to the predefined specification (e.g. the outermost element A1 of one module can be matched with the outermost element A5 of another module, B1 can be matched with B5). Modules can also be matched to each other at ends (30), according to the predefined specification (e.g. the end of element A1 of one module can be matched with the end of B1 of another module, etc.).

The example of embodiment provided above is one of the possible preferred embodiment of the invention. The number of elements in a module and the number of modules in a surface covering can be different from the solution provided in the preferred embodiment.

1. A surface covering with an irregular undulating edge, comprising unique irregular elements matched to one another sideways with undulating edge, wherein at least one element with irregular undulating edge with the shape of its edge at horizontal plane is by predefined specification at least partially compatible sideways with at least one adjacent element with irregular undulating edge, forming a module; an element of a module with at least one irregular undulating edge is unique; a unique element of a module with at least one irregular undulating edge can be replaced with an equal unique element with an irregular undulating edge of another module; modules can be matched mutually, at horizontal plane, to the shape of irregular undulating edge of the outmost element of a module, at least in part, according to the predefined specification; modules can be matched to each other at ends, according to the predefined specification; modules form a repeating pattern.

2. The surface covering with an irregular undulating edge according to claim 1, wherein the module comprises at least two unique elements with irregular undulating edge.

3. The surface covering with an irregular undulating edge according to claim 1, wherein the irregular undulating edge imitates the natural curvature of wood.

4. The surface covering with an irregular undulating edge according to claim 1, wherein the end of the module is at one horizontal plane.

5. The surface covering with an irregular undulating edge according to claim 1, wherein the end of the module is at different horizontal planes.

6. The surface covering with an irregular undulating edge according to claim 1, wherein the repeating pattern is formed of at least two modules.

7. The surface covering with an irregular undulating edge according to claim 1, wherein the surface covering forms a floor.

8. The surface covering with an irregular undulating edge according to claim 1, wherein the surface covering forms a wall.

9. The surface covering with an irregular undulating edge according to claim 1, wherein the surface covering forms a ceiling.

10. The surface covering with an irregular undulating edge according to claims 1, wherein the surface covering forms a worktop.

11. A surface covering with an irregular undulating pattern imitating natural warping of wood, comprising one or more modules, where each module comprises a multitude of elements having two longitudinal edges and two short edges,
wherein at least one longitudinal edge of each element has an undulating edge and said undulating edge having a predetermined shape such that it matches at least partially with an undulating edge of another element, and where the short ends of the elements are matching.

12. The surface covering of claim 11, wherein the covering comprises at least two modules, each module having one or more outermost elements, and said outermost elements having an undulating edge shaped such that it matches at least partially with an undulating edge of an outermost element of another module, whereby two modules are matched along their edge formed by a multitude of undulating edges of the outermost elements of the module.
